(19) United States
(12) Patent Application Publication
(10) Pub. No.: US 2011/0111139 A1
(43) Pub. Date: May 12, 2011

(54) LIQUID CRYSTAL ALIGNMENT LAYER AND METHOD FOR MANUFACTURING THE SAME

(75) Inventors: Hong-Cheu Lin, Hsinchu City (TW); Wei-Hong Chen, Yilan County (TW); Yung-Lung Mo, Taoyuan County (TW); Yun-Ching Chuang, Pingzhen City (TW); Szu-Fen Chen, Taoyuan County (TW)

(73) Assignee: Chunghwa Picture Tubes, Ltd., Taoyuan (TW)

(21) Appl. No.: 12/703,306

(22) Filed: Feb. 10, 2010

(30) Foreign Application Priority Data
Nov. 10, 2009 (TW) 098138040

(51) Int. Cl. C09K 19/56; B05D 5/06

(52) U.S. Cl. 428/1.23; 427/66

(57) ABSTRACT

A liquid crystal alignment layer and a method for manufacturing the same are provided. The liquid crystal alignment layer includes an organic material layer and a plurality of silicon dioxide particles. The plurality of silicon dioxide particles is formed on the organic material layer, and each silicon dioxide particle contains at least one amino (—NH₂) group.

### CROSS-REFERENCE TO RELATED APPLICATION

This application claims the benefit of Taiwan Patent Application No. 098138040, filed on Nov. 10, 2009, which is hereby incorporated by reference for all purposes as if fully set forth herein.

### BACKGROUND OF THE INVENTION

1. Field of Invention

The present invention relates to a liquid crystal alignment layer, and more particularly to an optically-compensated-birefringence (OCB) liquid crystal alignment layer.

2. Related Art

In recent years, the technologies associated with the flat-panel display industry such as liquid crystal displays (LCDs) have gradually become mature. Although the LCDs have the advantages of low radiation and being light, thin, short, and small, when a user views an LCD from different angles, the contrast ratio decreases as the viewing angle increases, thereby causing restrictions on the viewing angles. In addition, the response speed of the LCDs currently available on the market is still rather low, and as a result, blurring often occurs due to image retention when dynamic images are displayed.

Therefore, an OCB LCD device has been proposed, which can widen the viewing angle and improve the response speed of the LCD, so as to enhance the image quality of the LCD. Generally speaking, in an OCB operation mode, the OCB LCD device has the advantages of a high response speed and wide viewing angle, and thus has a great potential prospect.

However, in the OCB operation mode, each time when the OCB LCD device is driven, the OCB LCD device needs a preset period of time to enable liquid crystal molecules to be twisted from a splay mode to a bend mode at a proper position before working normally. Therefore, in order to enable the liquid crystal molecules to be twisted from the splay mode to the bend mode at the proper position, a certain driving voltage is required, and thus the response speed is slightly reduced, thereby resulting in a delayed response of the OCB LCD device.

### SUMMARY OF THE INVENTION

Accordingly, in order to solve the above problem, the present invention is directed to a liquid crystal alignment layer, which is applicable to improve the response speed of an LCD.

In addition, the present invention is also directed to a method for manufacturing a liquid crystal alignment layer, which is applicable to improve the response speed of an LCD.

To achieve the above objective, the present invention provides a liquid crystal alignment layer, which includes an organic material layer and a plurality of silicon dioxide particles. The plurality of silicon dioxide particles is formed on the organic material layer, and each silicon dioxide particle contains at least one amino (—NH₂) group.

In an embodiment of the present invention, the organic material layer is a polyimide layer.

In an embodiment of the present invention, the organic material layer contains a polyamic acid functional group.

In an embodiment of the present invention, the silicon dioxide particles are Si((NH₂R)SiO₃)₄, where R is C₁₋₆ alkyl.

In an embodiment of the present invention, the silicon dioxide particles are formed on the organic material layer by spin coating.

In an embodiment of the present invention, the liquid crystal alignment layer is applicable to an OCB LCD device.

The present invention further provides a method for manufacturing a liquid crystal alignment layer, which includes the following steps. Firstly, an organic material layer is formed on a glass substrate. Then, a plurality of silicon dioxide particles is formed on a surface of the organic material layer, in which each silicon dioxide particle contains at least one amino (—NH₂) group.

In an embodiment of the present invention, the organic material layer is a polyimide layer.

In an embodiment of the present invention, the organic material layer contains a polyamic acid functional group.

In an embodiment of the present invention, the silicon dioxide particles are Si((NH₂R)SiO₃)₄, where R is C₁₋₆ alkyl.

In an embodiment of the present invention, the silicon dioxide particles are formed on the organic material layer by spin coating.

In an embodiment of the present invention, the liquid crystal alignment layer is applicable to an OCB LCD device.

In order to make the aforementioned and other objectives and advantages of the present invention comprehensible, embodiments accompanied with figures are described in detail below.

### BRIEF DESCRIPTION OF THE DRAWINGS

FIG. 1 is a schematic view of a partial structure of an LCD device according to an embodiment of the present invention.

### DETAILED DESCRIPTION OF THE INVENTION

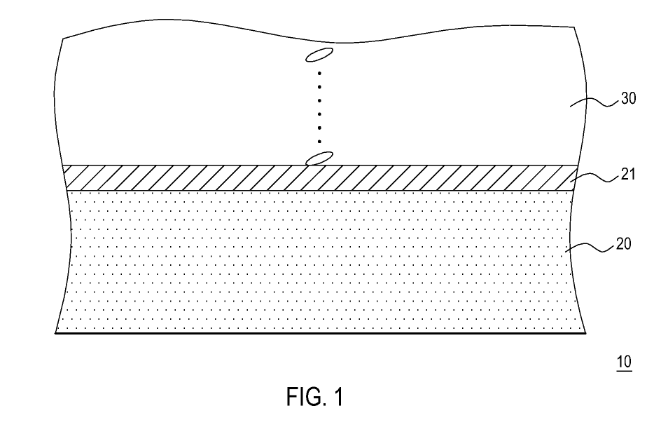

FIG. 1 is a schematic view of a partial structure of an LCD device according to an embodiment of the present invention. Referring to FIG. 1, an LCD device 10 includes a glass substrate 20, a liquid crystal alignment layer 21, and a liquid crystal layer 30. The glass substrate 20 has a surface, and the liquid crystal alignment layer 21 is formed on the surface of the glass substrate 20. The liquid crystal alignment layer 21 is an organic material layer containing a plurality of silicon dioxide particles.

In particular, the silicon dioxide particles are formed on a surface of the organic material layer. Since each silicon dioxide particle contains at least one amino (—NH₂) group, the crosslinking reaction occurs between the amino (—NH₂) group and polyamic acid in the organic material layer, thereby forming the silicon dioxide particles on the organic material layer.

The organic material layer may be a polyimide layer, and the silicon dioxide particles may be represented by Si((NH₂R)SiO₃)₄, where R is C₁₋₆ alkyl. For example, the silicon dioxide particles may be Si((NH₂C₃H₆)SiO₃)₄, as shown by General Formula (1).

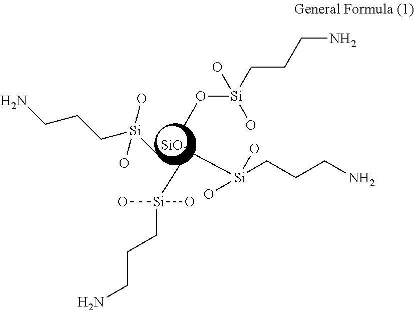

The silicon dioxide particles may be formed in a manner as shown by the following Chemical Formula (I), so that the silicon dioxide particles containing amino (—NH₂) groups are synthesized. It should be noted that, the synthesized silicon dioxide particles containing amino (—NH₂) groups have a size of 1-999 nanometers (nm).

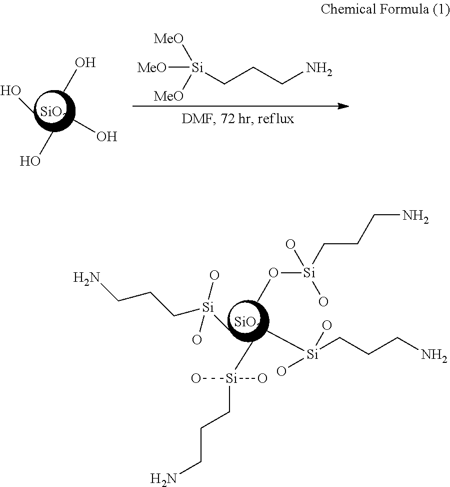

After the silicon dioxide particles containing amino (—NH₂) groups are synthesized, the silicon dioxide particles containing amino (—NH₂) groups are made to be reacted with the polyamic acid in the organic material layer. Since the crosslinking reaction occurs between the amino (—NH₂) group and the polyamic acid, the silicon dioxide particles may be formed on the organic material layer, thereby obtaining the liquid crystal alignment layer of the present invention.

The method for manufacturing a liquid crystal alignment layer of the present invention includes the following steps. Firstly, an organic material layer is formed on a glass substrate 20. Here, the organic material layer may be a common polyimide layer, or other organic material layers containing a polyamic acid functional group. Then, the synthesized silicon dioxide particles containing amino (—NH₂) groups are crosslinked with the surface of the organic material layer. As such, the manufacturing of the liquid crystal alignment layer 21 is completed.

In particular, the crosslinking process between the silicon dioxide particles containing amino (—NH₂) groups and the surface of the organic material layer may be implemented by the following manner. Firstly, the synthesized silicon dioxide particles are uniformly dispersed by ultrasonic vibration. Meanwhile, an organic material layer is coated on the glass substrate 20 by spin coating. Then, the silicon dioxide particles dispersed in ethanol are coated on the organic material layer by spin coating. Since the silicon dioxide particles contain amino (—NH₂) groups, the crosslinking reaction occurs between the amino (—NH₂) groups and the polyamic acid in the organic material layer, so that the silicon dioxide particles are formed on the organic material layer. As such, the manufacturing of the liquid crystal alignment layer 21 is completed.

A comparison embodiment and embodiments are provided below, and the influences of the silicon dioxide particles on the response time and the critical voltage and threshold voltage are discussed by comparing the cases that the liquid crystal alignment layer 21 includes no silicon dioxide particles containing amino (—NH₂) groups or includes different concentrations of silicon dioxide particles containing amino (—NH₂) groups.

In the following embodiments, the type of liquid crystals is, for example, pure OCB liquid crystals ZCE-5096; the organic material layer is coated on a glass substrate 20 by spin coating, and the organic material layer is formed by a polyimide layer (PIA-5580) and a diluent (NBG-776) at a ratio of 3:1; and the pre-curing conditions for the organic material layer are 110° C. for 30 min, and 220° C. for 10 min.

The silicon dioxide particles are coated on the organic material layer by spin coating, and the curing conditions for the silicon dioxide particles are 110° C. for 20 min, and 220° C. for 60 min. Here, different concentrations of silicon dioxide particles may be coated on the organic material layer, and the different concentrations refer to concentrations of the silicon dioxide particles dispersed in ethanol. Experimental results corresponding to silicon dioxide particles at concentrations of 0%, 0.01%, 0.05%, 0.1%, and 0.5% dispersed in ethanol are provided below.

Finally, in the embodiments with different concentrations of silicon dioxide particles, the liquid crystals ZCU-5096 are injected, and then, the response time and critical voltage of the liquid crystals are observed.

Table 1 shows results about the critical voltage when different concentrations of silicon dioxide particles are added, and Table 2 shows results about the response time when different concentrations of silicon dioxide particles are added. As known from the results in Tables 1 and 2, the silicon dioxide particles are most preferably added at a concentration of 0.1%. When the silicon dioxide particles are added at the concentration of 0.1%, the response time is reduced to 4.84 ms, compared with the response time of 5.79 ms when no silicon dioxide particle is added; and the critical voltage is reduced to 2.45 V, compared with the critical voltage of 3.50 V when no silicon dioxide particle is added. Therefore, as for the LCD device manufactured by adding a low concentration of silicon dioxide particles, the response speed can be effectively improved, and the driving voltage can be effectively reduced.

TABLE 1
Critical voltage of OCB cells added with different
concentrations of silicon dioxide particles

| OCB cell | Cell gap (μm) | Vcr (V) |
|---|---|---|
| OCB cell without SiO₂ | 3.6 | 3.50 |
| OCB cell with 0.01 wt % SiO₂ | 3.6 | 2.80 |
| OCB cell with 0.05 wt % SiO₂ | 3.7 | 2.45 |
| OCB cell with 0.1 wt % SiO₂ | 3.7 | 2.45 |
| OCB cell with 0.5 wt % SiO₂ | 3.7 | 2.39 |

TABLE 2
Response time of OCB cells added with different
concentrations of silicon dioxide particles

| | τ on (ms) | τ off (ms) | τ total (ms) |
|---|---|---|---|
| OCB cell without SiO₂ | 1.83 | 3.96 | 5.79 |
| OCB cell with 0.01 wt % SiO₂ | 1.84 | 3.98 | 5.82 |
| OCB cell with 0.05 wt % SiO₂ | 1.78 | 3.91 | 5.69 |
| OCB cell with 0.1 wt % SiO₂ | 1.23 | 3.21 | 4.84 |
| OCB cell with 0.5 wt % SiO₂ | 1.34 | 3.56 | 4.90 |

In the liquid crystal alignment layer and the method for manufacturing the same according to the present invention, the reaction between the silicon dioxide particles and the surface of the organic material layer is utilized to form a nano-structured alignment layer, so as to improve the response speed and reduce the driving voltage of the OCB LCD device.

As known by comparing the results in Tables 1 and 2, the liquid crystal alignment of the present invention surely has a faster response speed than the conventional OCB LCD device, such that the time and power required by the transition from the splay mode to the bend mode when the OCB LCD device is initially driven can be greatly reduced, and the instability phenomenon between the splay mode and the bend mode can also be eliminated, thereby achieving a faster response effect than the conventional LCD device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid crystal alignment layer, comprising:
an organic material layer; and
a plurality of silicon dioxide particles, formed on the organic material layer, wherein each of the silicon dioxide particles contains at least one amino (—NH₂) group.

2. The liquid crystal alignment layer according to claim 1, wherein the organic material layer is a polyimide layer.

3. The liquid crystal alignment layer according to claim 1, wherein the organic material layer contains a polyamic acid function group.

4. The liquid crystal alignment layer according to claim 1, wherein the silicon dioxide particles are Si((NH₂R)SiO₃)₄, where R is C₁₋₆ alkyl.

5. The liquid crystal alignment layer according to claim 1, wherein the silicon dioxide particles are formed on the organic material layer by spin coating.

6. The liquid crystal alignment layer according to claim 1, wherein the liquid crystal alignment layer is applicable to an optically-compensated-birefringence (OCB) liquid crystal display (LCD) device.

7. A method for manufacturing a liquid crystal alignment layer, comprising:
forming an organic material layer on a glass substrate; and
forming a plurality of silicon dioxide particles on a surface of the organic material layer, wherein each of the silicon dioxide particles contains at least one amino (—NH₂) group.

8. The method for manufacturing a liquid crystal alignment layer according to claim 7, wherein the organic material layer is a polyimide layer.

9. The method for manufacturing a liquid crystal alignment layer according to claim 7, wherein the organic material layer contains a polyamic acid function group.

10. The method for manufacturing a liquid crystal alignment layer according to claim 7, wherein the silicon dioxide particles are Si((NH₂R)SiO₃)₄, where R is C₁₋₆ alkyl.

11. The method for manufacturing a liquid crystal alignment layer according to claim 7, wherein the silicon dioxide particles are formed on the organic material layer by spin coating.

12. The method for manufacturing a liquid crystal alignment layer according to claim 7, wherein the liquid crystal alignment layer is applicable to an optically-compensated-birefringence (OCB) liquid crystal display (LCD) device.
